(19) United States
(12) Patent Application Publication
(10) Pub. No.: US 2011/0285599 A1
(43) Pub. Date: Nov. 24, 2011

(54) ANTENNA

(75) Inventor: Leslie David SMITH, Cambridgeshire (GB)

(73) Assignee: Cambridge Silicon Radio Limited, Cambridge (GB)

(21) Appl. No.: 13/109,515

(22) Filed: May 17, 2011

(30) Foreign Application Priority Data
May 21, 2010 (GB) GB 1008492.9

(51) Int. Cl. H01Q 21/00

(52) U.S. Cl. 343/843; 343/893

(57) ABSTRACT

An antenna comprising a substrate (12) having on a first side a first antenna element (16, 32) and on a second side a second antenna element (18, 34) which is of a different length to the first antenna element (16,32).

### TECHNICAL FIELD

The present invention relates to an antenna, and in particular to an antenna suitable for use in radio systems such as Bluetooth® and Wi-Fi® which use the 2.4 GHz frequency band, to a wireless subsystem module including such an antenna, and to a device such as a mobile telephone or laptop computer including such an antenna.

### BACKGROUND TO THE INVENTION

Many portable devices such as laptop computers, mobile telephones and the like include wireless subsystems such as Bluetooth® and Wi-Fi®. Typically manufacturers of such portable devices require modules implementing wireless subsystems which are less than a quarter of a wavelength long for an operating frequency of 2.45 GHz. For an efficient antenna system, a length of half of the operating wavelength would be preferred. A further requirement is that these modules must be low-cost, which precludes the use of expensive ceramic materials in the antennas of the wireless subsystems.

It is commonplace to use printed antennas in modules providing wireless subsystems, as they can be implemented at low cost. However, in a module less than a quarter of a wavelength long for an operating frequency of 2.45 GHz, a printed antenna typically has a radiation resistance of around 4 ohms. To match the radiation resistance of the antenna to the output resistance of a circuit to which the antenna is connected, which is typically around 50 ohms, a 46 ohm resistor may be placed in series with the antenna. However, resistors are lossy components, and the use of resistors to match the antenna resistance to that of the circuit to which the antenna is connected can give rise to losses of 10*log(4/46)=10 dB (where “log” is the base 10 logarithm), resulting in an antenna that is only 10 percent efficient.

In some systems a circuit comprising inductors and capacitors is used to match the impedance of the antenna to that of the circuit to which the antenna is connected. However, capacitors and inductors are subject to manufacturing tolerances which can make exact matching uneconomical in high volume applications.

### SUMMARY OF INVENTION

According to a first aspect of the present invention there is provided an antenna comprising a substrate having on a first side a first antenna element and on a second side a second antenna element which is of a different length to the first antenna element

The antenna of the present invention offers a significant increase in the bandwidth of the antenna, due to the use of two antenna elements of different lengths. This increased bandwidth reduces the antenna's susceptibility to manufacturing tolerances of impedance matching inductors and capacitors, as the antenna is able to transmit and receive signals over a wider frequency range and thus the circuit to which the antenna is connected need not be precisely tuned to a particular frequency, but can produce output signals and receive incoming signals in a broader frequency range whilst still providing acceptable performance.

One of the first and second antenna elements may be a meander antenna element.

Alternatively, both of the first and second antenna elements may be meander antenna elements.

The second side of the substrate may be generally opposed to the first side.

A path of the second antenna element may be different from a path of the first antenna element

For example, the path of the second antenna element may substantially mirror the path of the first antenna element.

The first and second antenna elements may be substantially sinusoidal.

The first and second antenna elements may be printed antenna elements.

According to a second aspect of the invention there is provided a wireless subsystem module comprising an antenna according to the first aspect of the invention.

The wireless subsystem module may have a total length which is approximately equal to a quarter of the operating wavelength of the wireless subsystem module.

According to a third aspect of the invention there is provided a device comprising an antenna according the first aspect of the invention.

### BRIEF DESCRIPTION OF THE DRAWINGS

Embodiments of the invention will now be described, strictly by way of example only, with reference to the accompanying drawings, of which:

FIG. 1 is a schematic representation of a wireless subsystem module including antenna according to an embodiment of the present invention;

FIG. 2 is a plot showing the frequency response of a simulated antenna according to the present invention; and

FIG. 3 is a schematic representation of an antenna according to an alternative embodiment of the present invention.

### DESCRIPTION OF THE EMBODIMENTS

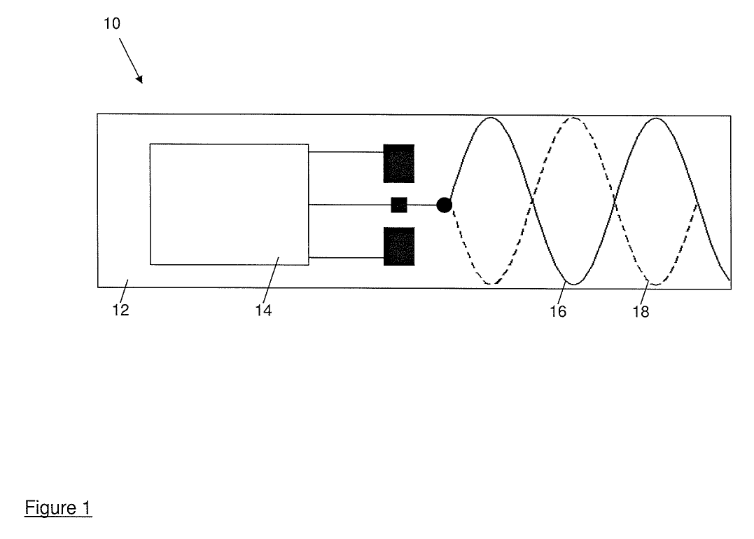

Referring first to FIG. 1, a wireless subsystem module for use in a device such as a mobile telephone or a laptop computer is shown generally at 10. The wireless subsystem module 10 is mounted on a substrate 12 of a material such as fibreglass, for example FR4, which supports a plurality (for example four) of circuit layers, one of which is at ground or 0 volts potential and is referred to as a “ground plane”.

One or more integrated circuits 14 containing transmit and receive circuits is mounted on the substrate 12 and is connected by tracks printed or otherwise provided on the layers of the substrate 12 to a number of discrete components such as filters, resistors, capacitors and inductors which perform functions such as impedance matching of the transmit and receive circuits to an antenna of the wireless subsystem module 10. The structure and operation of these components will not be described in detail here, since they are not the focus of the present invention.

The wireless subsystem module 10 includes first and second antenna elements 16, 18 which are connected to the wireless subsystem module 10 and which form, with the ground plane, an antenna of the wireless subsystem module 10. The exemplary wireless subsystem module 10 illustrated in FIG. 1 is for use in a wireless system such as Bluetooth® or Wi-Fi® which operate in the 2.4 GHz frequency band, but it will be appreciated that the principles of the present invention are equally applicable to other wireless systems which operate in different frequency bands.

At 2.45 GHz the wavelength of an electromagnetic wave in air is approximately 122 mm. The wireless subsystem module 10 illustrated in FIG. 1 has a length of approximately 30 mm, which is just under a quarter of the operating wavelength of the wireless subsystem. Manufacturers of devices such as mobile telephones and laptop computers commonly demand wireless subsystem modules implementing Bluetooth® or Wi-Fi® functionality, for example, of this size.

The first antenna element 16 (shown as an unbroken line in FIG. 1) is provided on an upper surface of the substrate 12, towards one end thereof, and is a meander antenna element taking the form of a generally sinusoidal conductor printed or otherwise provided on an upper surface of the substrate 12. The second antenna element 18 (shown as a dashed line in FIG. 1) is provided on a lower surface of the substrate 12, which is generally opposed to the upper surface, and again is a meander antenna element taking the form of a generally sinusoidal conductor printed or otherwise provided on the lower surface of the substrate 12. The first (upper) antenna element 16 is slightly longer than the second antenna element 18. As can be seen from FIG. 1, the path of the second (lower) antenna element 18 is different from that of the first (upper)) antenna element 16, to reduce the effects of capacitive coupling between the first and second antenna elements 16, 18. In this example, the path of the second (lower) antenna element 18 mirrors, or is opposite to, the path of the first (upper) antenna element 16. This prevents or at least reduces the effects of capacitive coupling between the first and second antenna elements 16, 18 to a minimum so that currents in the first antenna element 16 do not induce currents in the second antenna element 18 and vice versa, whilst making the best and most efficient use of the space available on the substrate 12.

In operation of the wireless subsystem module 10, the first antenna element 16 resonates at a slightly different frequency than the second antenna element 18. This has the effect of increasing the frequency range in which the wireless subsystem module 10 can operate, since the first and second antenna elements 16, 18 can transmit and receive signals effectively in two different but overlapping frequency ranges.

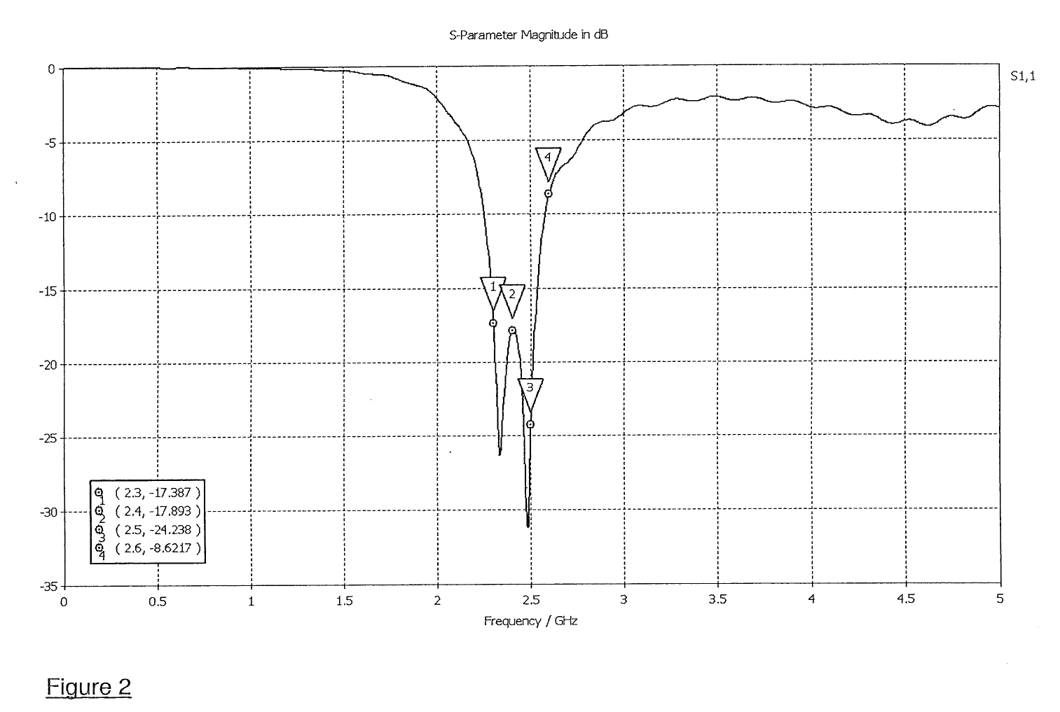

This is illustrated in the plot of FIG. 2, which shows the frequency response of a simulated antenna having first and second antenna elements 16, 18, as shown in FIG. 1. It can clearly be seen in FIG. 2 that there are two distinct peaks in the frequency response of the antenna, indicating that the antenna can operate effectively in a broader frequency range than an antenna having only a single antenna element. In practice, for an antenna of this type operating in the 2.4 GHz frequency band the two peaks merge into a single peak covering a broader frequency range than an antenna having only a single antenna element.

This broader frequency range is advantageous, as it reduces the need for precise tuning of the circuit to which the antenna is connected. This in turn permits relatively inexpensive components such filters, capacitor, resistors and inductors with higher tolerances to be used in the wireless subsystem module 10, helping to reduce the overall cost of the wireless subsystem module 10.

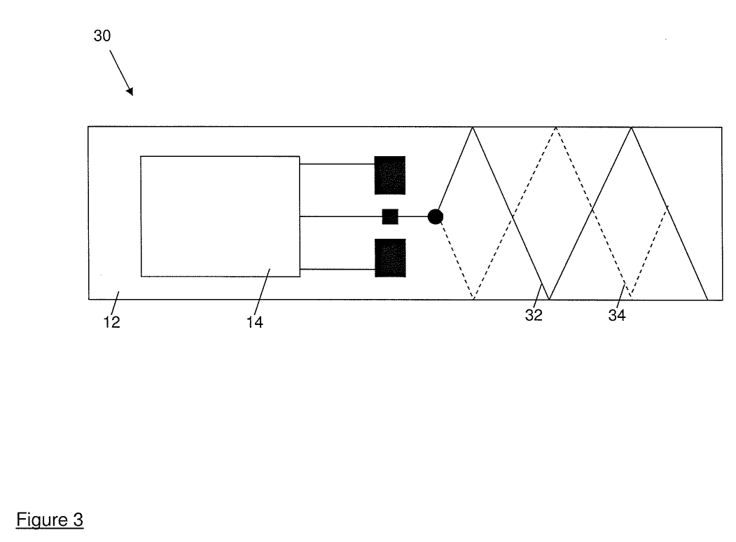

FIG. 3 is a schematic illustration of a wireless subsystem module having an alternative antenna configuration. As many of the elements of the wireless subsystem module shown in FIG. 3 are the same as those of the wireless subsystem module shown in FIG. 1, the same reference numerals are used to designate elements common to the modules shown in FIGS. 1 and 3.

The wireless subsystem module is shown generally at 30 in FIG. 3, and, as in the embodiment illustrated in FIG. 1, includes a substrate 12 of a material such as fibreglass, for example FR4, which supports a plurality (for example four) of circuit layers, one of which is at ground or 0 volts potential and is referred to as a “ground plane”.

An integrated circuit 14 containing transmit and receive circuits is mounted on the substrate 12 and is connected by tracks printed or otherwise provided on the layers of the substrate 12 to a number of discrete components such as filters, resistors, capacitors and inductors which perform functions such as impedance matching of the transmit and receive circuits to an antenna of the wireless subsystem module 30. Again, as these components are peripheral to the present invention, their structure and operation will not be described in detail here.

The wireless subsystem module 30 includes first and second antenna elements 32, 34 (shown as unbroken lines and dashed lines, respectively, in FIG. 3) which are connected to the wireless subsystem module 30 and which form, with the ground plane, an antenna of the wireless subsystem module 30. Again, the exemplary wireless subsystem module 30 illustrated in FIG. 3 is for use in a wireless system such as Bluetooth® or Wi-Fi® which operate in the 2.4 GHz frequency band, but it will be appreciated that the principles of the present invention are equally applicable to other wireless systems which operate in different frequency bands.

In the embodiment illustrated in FIG. 3, the first and second antenna elements 32, 34 are meander antenna elements, taking the form of conductors of a generally triangle wave shape which are printed or otherwise provided, respectively, on upper and lower surfaces of the substrate 12. The first (upper) antenna element 32 is slightly longer than the second antenna element 34. As can be seen from FIG. 3, the path of the second (lower) antenna element 34 is different from that of the first (upper) antenna element 32. This reduces the effects of capacitive coupling between the first and second antenna elements 32, 34. In this example the path of the second (lower) antenna element 34 mirrors, or is opposite to the path of the first (upper) antenna element 32. Again, this prevents or at least reduces to a minimum the effects of capacitive coupling between the first and second antenna elements 32, 34 so that currents in the first antenna element 32 do not induce currents in the second antenna elements 34, and vice versa. The arrangement illustrated in FIG. 3 provides the same advantages as that shown in FIG. 1 in terms of increased operating frequency range as compared to systems which employ only one antenna element.

Although the exemplary embodiments illustrated in FIGS. 1 and 3 include meander antenna elements 16, 18, 32, 34, the advantages of the present invention can be achieved using different forms of antenna elements. For example, the antenna elements could be substantially straight, provided that one of the first and second antenna elements is longer than the other of the first and second antenna elements, such that it resonates at a different frequency from the other, to achieve the effect of increasing the operating frequency range in comparison to systems which employ single antenna elements.

Similarly, although the exemplary embodiments illustrated in FIGS. 1 and 3 have first and second antenna elements 16, 18, 32, 34 which are provided on opposed upper and lower surfaces of the substrate 12, other configurations are possible. For example, if the substrate 12 is sufficiently deep, the first antenna element 16, 32 may be provided on the upper or lower surface of the substrate, with the second antenna element 18, 34 being provided on a side surface of the substrate 12.

1. An antenna comprising a substrate having on a first side a first antenna element and on a second side a second antenna element which is of a different length to the first antenna element.

2. An antenna according to claim 1 wherein one of the first and second antenna elements is a meander antenna element.

3. An antenna according to claim 2 wherein the first and second antenna elements are meander antenna elements.

4. An antenna according to claim 1 wherein the second side of the substrate is generally opposed to the first side.

5. An antenna according to claim 3 wherein a path of the second antenna element is different from a path of the first antenna element

6. An antenna according to claim 5 wherein the path of the second antenna element substantially mirrors the path of the first antenna element.

7. An antenna according to claim 5 wherein the first and second antenna elements are substantially sinusoidal.

8. An antenna according to claim 1 wherein the first and second antenna elements are printed antenna elements.

9. A wireless subsystem module comprising an antenna according to claim 1.

10. A wireless subsystem module according to claim 9 wherein the total length of the wireless subsystem module is approximately a quarter of the operating wavelength of the wireless subsystem module.

11. A device comprising an antenna according to claim 1.
